(19) United States
(12) Patent Application Publication
(10) Pub. No.: US 2016/0302890 A1
(43) Pub. Date: Oct. 20, 2016

(54) Orthodontic Retainer

(71) Applicant: James Patrick Hamilton, Naas (IE)

(72) Inventor: James Patrick Hamilton, Naas (IE)

(21) Appl. No.: 14/690,503

(22) Filed: Apr. 20, 2015

(51) Int. Cl. A61C 7/20

(52) U.S. Cl. CPC A61C 7/20

(57) ABSTRACT

A dental retainer system for the stabilisation, so-called retention, of pairs of teeth or groups of teeth in the upper or lower jaws. The retainer device consists of a series of interlocking retainer elements that are applied to adjacent teeth in a patient's mouth to form one continuous retainer. The retainer elements may be provided in the form of interlocking metal wire sections, of varying dimensions, bonded to the teeth with dental adhesive, so that two or more teeth may be linked together. In one embodiment, one end of the first retainer element fits in the receiving portion of the second retainer element, with the dental adhesive serving to attach two or more sections to each other and to the tooth. Thereby, pairs of teeth or groups of teeth are linked together to prevent movement of the said teeth.

### TECHNICAL FIELD

This invention relates to a dental retention device, also called a dental retainer, for use in patients who have undergone orthodontic treatment, or for some other reason need to have pairs of teeth or groups of teeth retained or stabilized, in the lower and/or upper jaw(s).

### BACKGROUND OF THE INVENTION

Orthodontic treatment mainly consists of a period of active treatment and a period of inactive treatment. In the period of active treatment the teeth are moved to the desired positions in the jaw(s). The period of active treatment is then followed by a period of inactive treatment, also referred to as the retention period, during which the teeth concerned are sought to be stabilised, or retained, in the positions obtained. Therefore, in the retention period orthodontic patients must wear suitable retainers on a full-time or part-time basis, in order thereby to ensure that the tooth positions obtained are maintained over time.

Known retainers comprise removable retainers and fixed retainers. A removable retainer is formed of plastic-based retainer plates, which are often combined with steel retentive and active components (Hawley retainer), or by a thin plastic sheet which is heated and formed to a model of the patient's teeth using a vacuum (vacuum-formed retainer). The removable retainer is used during parts of the day, usually at night, which means that the patient must be instructed on the use and maintenance of the retainer.

A fixed retainer is essentially formed of orthodontic wire, also called retainer wire, the wire being cut into suitable lengths and adapted for the pair of teeth or segment of teeth in question. The orthodontic wire can vary in type, including individual wire or twisted wire; in cross-section, including round, square or rectangular cross-sections; and in type of metal(s), alloy(s), resin or plastic.

The wire can either be attached directly to the individual teeth by a suitable dental bonding material, e.g. composite material, in the form of small lumps of glue or, the ends of the wire are soldered to orthodontic pads which are then attached to the end teeth of the group, with the intervening teeth touching the body wire.

Fixed retainers are preferably used on the inside of the dental arch at the front of the lower jaw (lingually) and to a somewhat lesser extent on the inside of the dental arch at the front of the upper jaw (palatally).

To achieve a good result by the use of a removable retainer, one is completely dependent on the patient's will and ability to cooperate and maintain the retainer correctly. Moreover, removable retainers do not maintain exact tooth position, so that limited tooth movement may occur even when they are worn as directed. Also, the plates can be uncomfortable to wear and be prone to break easily, which makes removable retainer plates unsuitable for retention lasting several years.

The use of a fixed retainer makes dental hygiene procedures more difficult, with plaque and tartar accumulating around the retainer wire, especially when placed on the lingual (tongue) side of the lower teeth. As a fixed retainer extends continuously from tooth to tooth in the region covered by the retainer, the use of dental floss is difficult.

Also, less commonly, tooth movement may occur even when the fixed retainer remains attached due to the wire not being placed in a passive state.

When fixed retainer wires are used, the desired tooth positions are secured best when the wire is glued to each tooth in the involved group of teeth, or retention segment. However, breaks may occur between tooth and bonding material, or with the retaining wire itself. These breaks may be difficult to discover for the patient. Often this will not be discovered until the teeth concerned have moved away from the desired tooth positions, to a larger or smaller degree. This results in a poorer aesthetic result and occasionally requires retreatment to realign the teeth concerned.

Repair of broken fixed retainers requires reattachment of the loose section of wire to the tooth (or teeth) or replacement of all, or a section of, the retainer wire.

The retainer wire may be adapted to the desired surfaces of the teeth by a technician, or directly in the patient's mouth by the dentist. When performed by a technician, this requires a mould of the patient's teeth to be taken, with the construction of a model (usually in stone) from this mould. An additional appointment is then required to fit the said fixed retainer. Additionally, the fabrication of the retainer by a technician requires the payment of a fee for the laboratory work.

When the retainer is fabricated by the dentist directly in the patient's mouth, substantial clinical time is needed to ensure correct adaptation and bonding of the retainer to the desired teeth. Also, as described earlier, if the retainer is not placed on the target teeth in a passive state, undesired tooth movement may occur.

Partially flexible retainer wires have been developed to allow quick adaptation of the retainer to the teeth to be retained. However, as these wires are not rigid, the potential for adverse tooth movement exists.

### SUMMARY OF THE INVENTION

The object of the invention is to provide a dental retainer for the stabilisation of teeth, primarily for use after orthodontic treatment. The retainer design allows for ease of placement and adaptation to the tooth surfaces without the need for placing bends in the wire or without the involvement of a dental technician. The invention ensures that the retainer wire is passive when seated thus reducing the potential for unwanted tooth movement. Also, should the fixed retainer become debonded from the teeth or the wire fracture, repair of the retainer is facilitated.

The object is realised through the use of one or more interlocking, complimentary or co-operating retainer elements, of various dimensions, which are bonded with dental adhesive, e.g. dental composite, glass ionomer cement or compomer, to the lingual, palatal, or occasionally the buccal surfaces of the teeth in the retainer group, to form one continuous wire segment.

A retainer element consists of section of wire, one end of which has a male (protrusive) portion, the opposite end of which has a female (receiver) portion. The distances between the centres of the teeth to be retained are measured and retainer elements corresponding with these dimensions are chosen. Retainer elements are placed so that the male portion of one retainer element interlocks with the female portion of the adjacent element. Two or more such elements are joined together and fixed at the position of the interlocking joint with dental adhesive, e.g. dental composite, to the desired teeth. The retainer is extended to adjacent teeth by adding additional elements resulting in a continuous rigid retainer.

The retainer elements could vary in configuration depending on the particular demands of the clinical situation. For example the clinician could impart bends to the retainer elements to allow closer adaptation of the said elements to the teeth, possibly to compensate for variation in size or position of the tooth or teeth to be retained. Alternatively, the co-operating retainer elements could themselves interlock to form a rigid joint without the addition of dental adhesive. Thus, different sizes, shapes and configurations of retainer elements could be combined to fabricate a dental retainer which is individual to each patient.

Common to all the possible configurations of retainer elements is that their complementary geometric shapes allow adjacent elements to mutually support or possibly interlock with each other, so that with (or without) dental adhesive they have a stabilising effect on each other and on the teeth to which they are bonded.

The retainer elements are preferably placed inside the dental arch, on the cingulum plateau of the desired teeth, so that the resultant continuous retainer is parallel to the tooth approximal surfaces of the two or more adjacent teeth.

### DESCRIPTION OF THE DRAWINGS

In the following part of the description, and with reference to FIGS. 1-16, different non-limiting exemplary embodiments of retainer elements, two or more interlocking retainer elements, and a method of application to the target teeth will be shown.

FIG. 1 depicts 3 interlocking retainer elements viewed from the top (occlusal or plan view) and from the rear (palatal) without showing the adhesive or tooth surfaces. The male end has a bend placed perpendicular to the body wire, where the female end has a closed loop.

FIG. 2 depicts a cross section of the same retainer elements shown in FIG. 1. The target tooth and the adhesive used to bond the retainer elements to each other and to the target tooth is also depicted. The cross section is taken through the widest dimension of the interlocked retainer elements.

FIG. 3 shows a perspective view of the same interlocked retainer elements depicted in FIGS. 1 and 2.

FIG. 3a depicts a complete retainer in perspective view on the palatal surface of the teeth in the upper jaw. This retainer will typically extend from canine tooth to the opposite canine tooth in the same dental arch (six interlocking elements), but may have fewer elements depending on the clinical situation. The terminal element in the retainer chain may be designed with the same distal and proximal end.

FIG. 4 depicts 3 interlocking retainer elements viewed from the top (occlusal or plan view) and from the rear (palatal) without showing the adhesive or tooth surfaces. These elements differ from those shown in FIG. 2 in that there is more space for dental adhesive at the co-operating interface. Also, a bend is placed in the female (receiving) retainer element to facilitate closer adaptation with the male element.

FIG. 5-5a depict perspective views of a pair of retainer elements being placed into the position of use on the desired tooth. One embodiment of the bonding procedure required to link complementary retainer elements together is that the male retainer element is placed in a bed of dental adhesive after the receiving tooth surface has been appropriately conditioned to receive the adhesive (FIG. 5). The female retainer element is interlocked with the male element which is already in position, further dental adhesive is added with rigidity imparted to the entire retainer-adhesive complex by the polymerisation of the dental adhesive.

FIG. 6 is a perspective view of co-operating retainer elements with bends placed in the body wires to facilitate close adaptation to each other and to the underlying tooth.

FIG. 7 is an expanded perspective view of the interlocking section of the retainer elements shown in FIG. 4.

FIG. 8 is an expanded perspective view of several of the retainer elements described in FIGS. 4 and 7 placed in the position of use.

FIG. 10 shows another embodiment of the retainer where a bend is placed in the body wire at the male end of the retainer element to allow close adaptation to the complementary element

FIG. 11 depicts a retainer element, in perspective view, where the distal and proximal ends both have a female attachment unit. The complementary co-operating unit could have male attachment units at distal and proximal ends.

FIG. 12 is a perspective view of co-operating retainer elements placed in the position of use where a bend is placed in the body wire to correspond to the interproximal surface of adjacent teeth. This will further enhance adaptation to the teeth to be retained.

FIG. 13 is a depiction of the co-operating ends of two adjacent retainer elements, in perspective view, where the male end has a ball design and the female end has a clasp design.

FIG. 14 is a depiction of the co-operating ends of two adjacent retainer elements, in perspective view, where the male end has vertical bend placed perpendicular to the body wire while the female end has a C-shaped (open loop design).

FIG. 15 is a depiction of the co-operating ends of two adjacent retainer elements, in perspective view, where the male end has vertical bend placed perpendicular to the body wire while the female end has a closed loop design which incorporates a bend to facilitate close adaptation to the complementary male component.

FIG. 16 depicts six retainer elements described in FIG. 14, in perspective view, placed in the position of use.

1. A dental retainer system for the stabilisation of pairs or groups of teeth, usually after orthodontic treatment. The dental retainer system consists of individual retainer elements with complementary shapes to one another, one end of which has a male portion, the opposite end of which has a female (receiver) portion. The distances between the centres of the teeth to be retained are measured and retainer elements corresponding with these dimensions are chosen. Retainer elements are placed so that the male portion of one retainer element abuts with the female portion of the adjacent element. Two or more such elements are joined together and fixed at the position of the interlocking joint with dental adhesive, to the desired teeth. The retainer is extended to adjacent teeth by adding additional elements resulting in a continuous rigid retainer. Thus the individual retainer elements are stabilised relative to each other and also stabilised relative to the teeth to which they are attached.

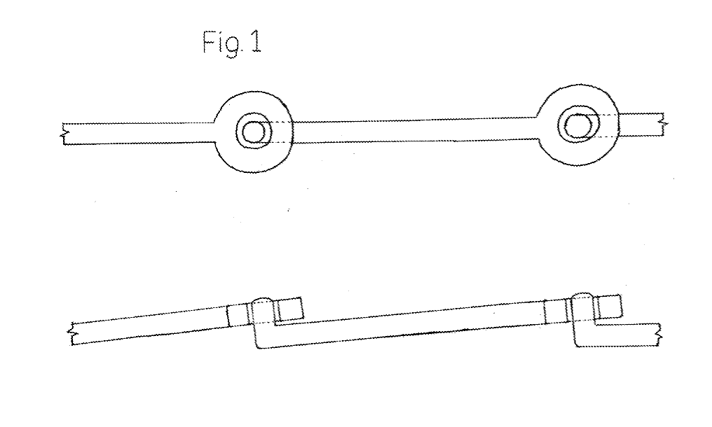

2. One embodiment of the retainer in claim 1 has a male portion at right angles to the body wire and a circular female portion which fits over the male portion. This is depicted in FIG. 1.

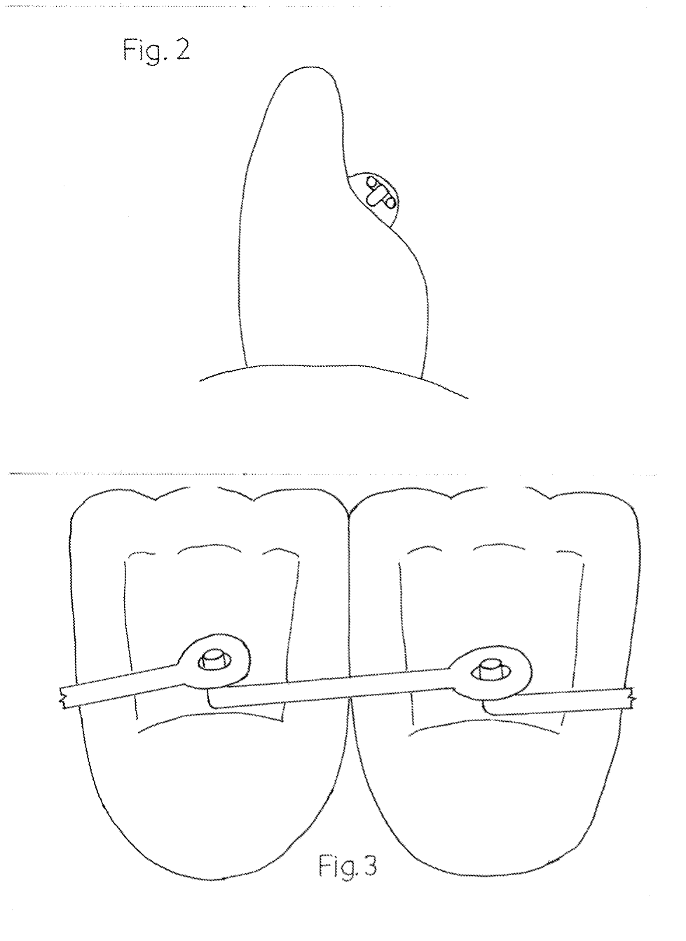

3. One embodiment of the retainer in claim 2 has a male portion at right angles to the body wire and a circular female portion which fits over the male portion and includes a bend in the body wire to aid positioning on the said male component. This is depicted in FIG. 2.

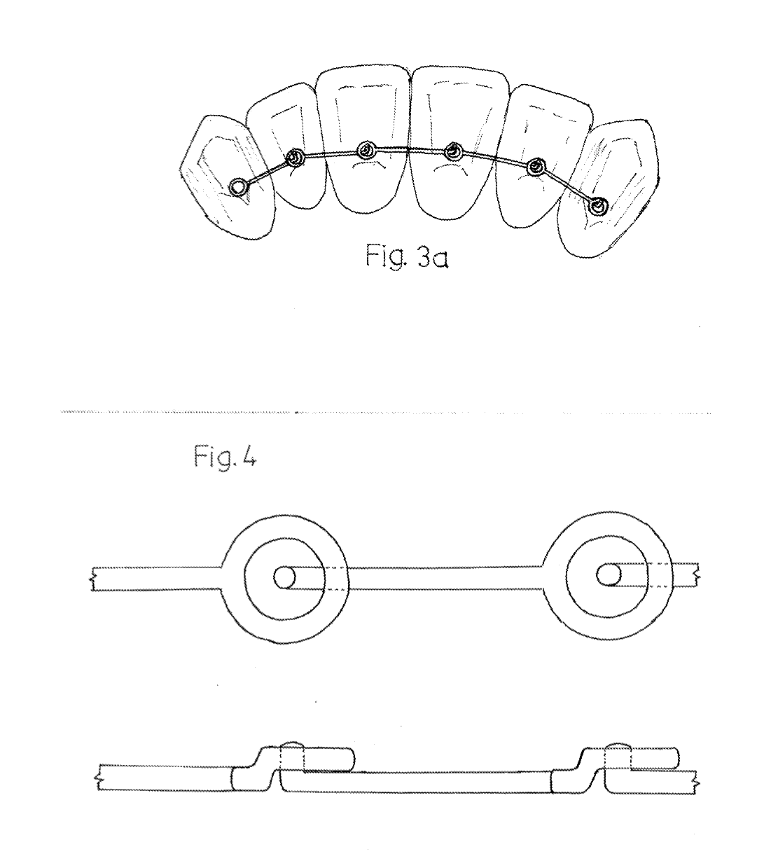

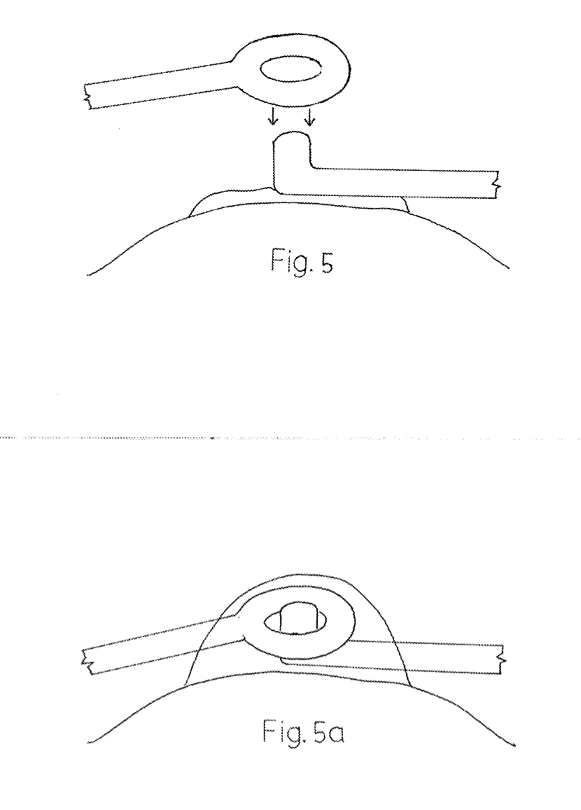

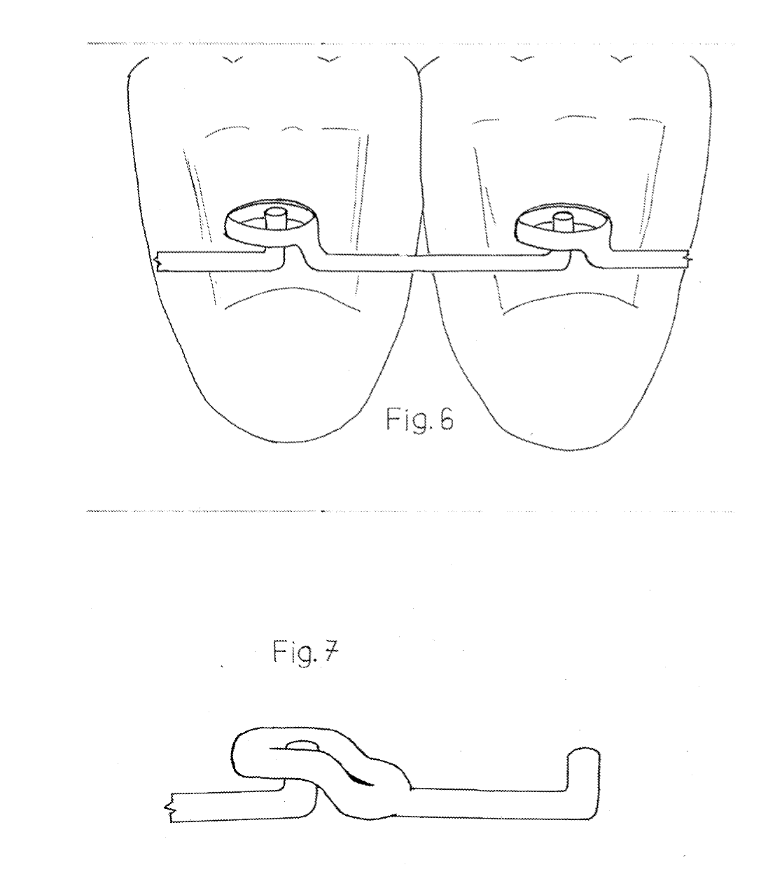

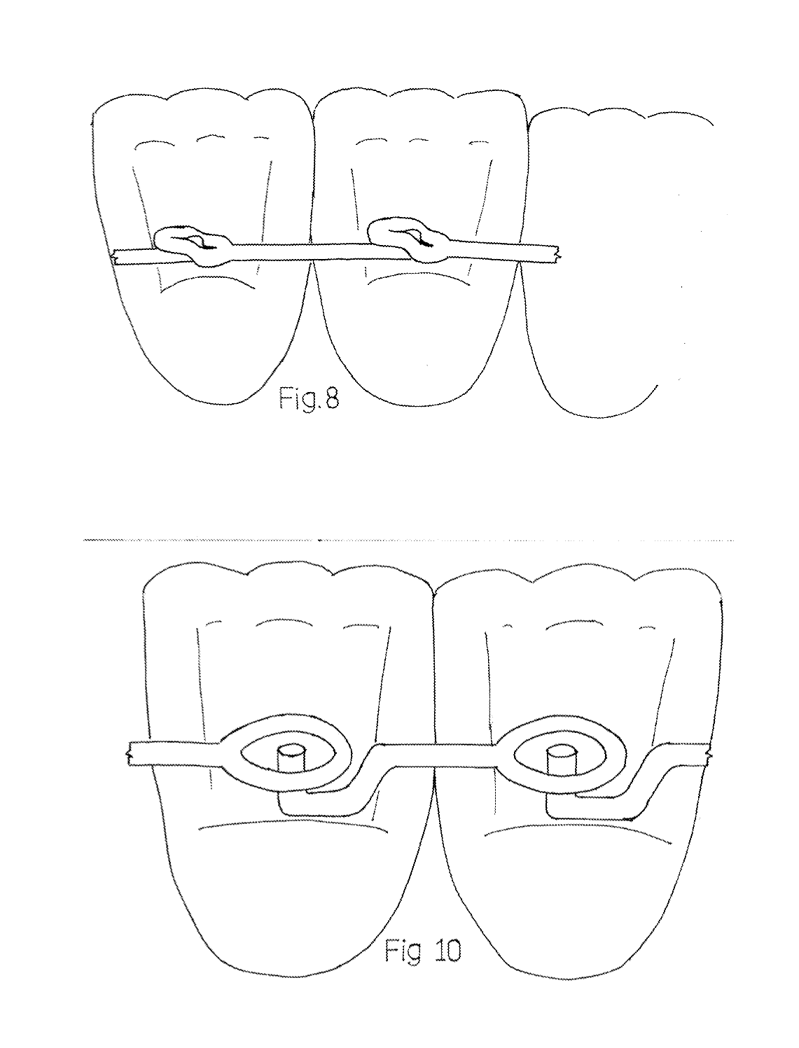

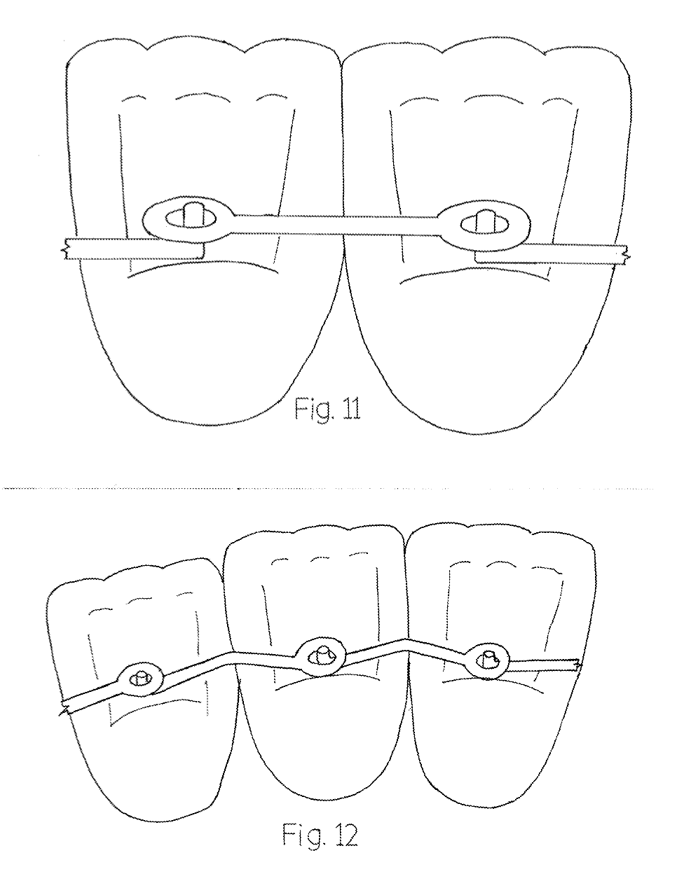

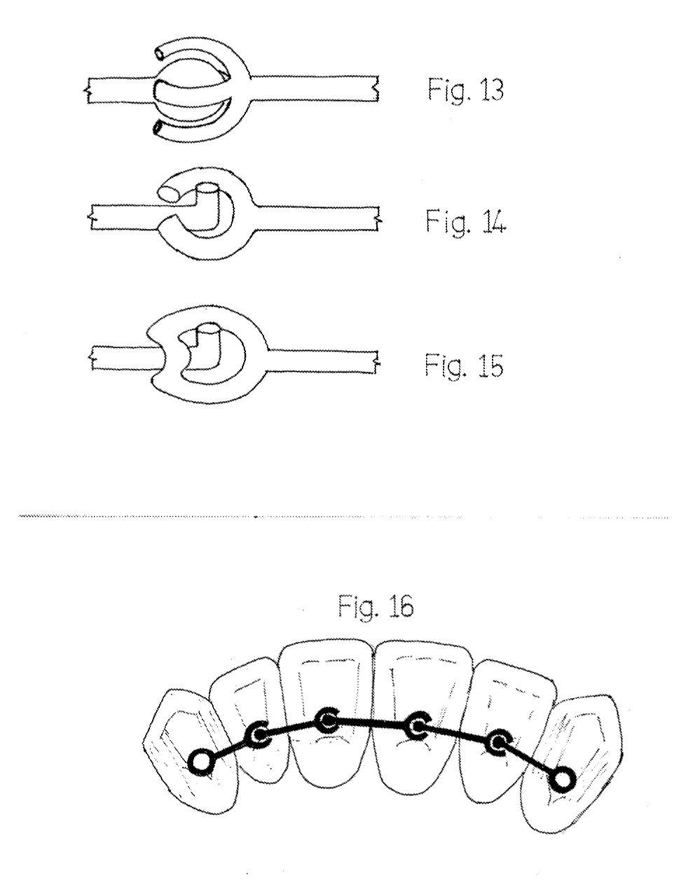

4. One embodiment of the retainer in claim 1 has a male portion in line with the body wire and a C-shaped female portion which co-operates with the male portion. This is depicted in FIG. 3.

5. One embodiment of the retainer in claim 4 has a male portion at right angles to the body wire and a C-shaped female portion which co-operates with the male portion. This is depicted in FIG. 3.

6. One further embodiment of the retainer in claim 4 has a male portion in line with the body wire and includes a bulbous end section and a C-shaped female portion which co-operates with the male portion. This is depicted in FIG. 3.

7. One embodiment of the retainer in claim 1 has a male portion in line with the body wire and includes a bulbous end section and multi-pronged female portion which clasps the male portion. This is depicted in FIG. 4.

8. One further embodiment of the retainer in claim 1 has a plurality of shapes of the male and female portions, the shapes of which are complementary to each other, so that when placed in the position of use the mutual contact surfaces may be locked with respect to each other.

9. The dental retainer apparatus of claim 1 may have space between the co-operating elements, allowing movement between the elements. This space will be occupied by the dental adhesive used to bond the retainer elements to the teeth and imparts rigidity to the resultant joint.

10. One further embodiment of the retainer in claim 1 has frictional contact between the co-operating elements, locking the individual elements with respect to each other and imparting rigidity to the resultant joint. The dental adhesive is then used to bond the retainer elements to the teeth.

11. One further embodiment of the retainer in claim 1 is that the male and female portions of the same retainer element are angulated with respect to each other by virtue of the addition of a bend, or bends, to the body section of the retainer element.

12. One additional embodiment of the retainer in claim 11 has additional bends in the body section of the retainer element with the male and female portions of the retainer element remaining linear to each other.

13. One further embodiment of the retainer in claim 1 has magnetic contact between the co-operating elements, each complementary element having a magnet of opposite polarity.

14. The dental retainer apparatus in claim 1 may be fabricated from metal or metal alloy, (which may be cast or milled), metal wires (which may be single stranded or multi-stranded), ceramic, resin, plastic or any other appropriate material.

15. The dental retainer apparatus in claim 1 may have round, rectangular, square, oval, and elliptical or any plurality of cross-sectional shapes.

16. The dental retainer apparatus in claim 1 may be fabricated from material which is smooth, sand blasted, acid etched, perforated or any plurality of treatments to enhance retention of the elements to each other or to the teeth in the retention segment.
